(19) United States
(12) Patent Application Publication
(10) Pub. No.: US 2022/0135371 A1
(43) Pub. Date: May 5, 2022

(54) CONTROL DEVICE, METHOD OF DETERMINING TRIGGERING OF THE CONTROL DEVICE AND ELEVATOR SYSTEM

(71) Applicant: Otis Elevator Company, Farmington, CT (US)

(72) Inventors: Heping Qiu, Shanghai (CN); Xiaofei Guo, Shanghai (CN); Renjie Zeng, Shanghai (CN)

(21) Appl. No.: 17/390,309

(22) Filed: Jul. 30, 2021

(30) Foreign Application Priority Data
Nov. 3, 2020 (CN) 202011208853.6

(51) Int. Cl. B66B 1/46; G08B 5/36; B66B 3/00; G01S 17/08

(52) U.S. Cl. CPC B66B 1/468; G08B 5/36; B66B 3/002; B66B 2201/101; B66B 2201/4638; B66B 2201/463; G01S 17/08

(57) ABSTRACT

A control device, a method for determining triggering of a control device, and an elevator system. The control device includes a control panel including a plurality of buttons, and the buttons include: a non-contact sensor, which is capable of sensing the approaching of an object and generating a proximity signal; and a micro switch, which is capable of generating a contact signal when the button is pressed.

### FOREIGN PRIORITY

This application claims priority to Chinese Patent Application No. 202011208853.6, filed Nov. 3, 2020, and all the benefits accruing therefrom under 35 U.S.C. § 119, the contents of which in its entirety are herein incorporated by reference

### FIELD

The present disclosure relates to the field of control devices, and more specifically, the present disclosure relates to an elevator control device, a method for determining triggering of an elevator control device, and an elevator system.

### BACKGROUND

Recently, in response to the pandemic of the new coronavirus, major manufacturers have all focused on the research of non-contact elevator control devices. Existing non-contact elevator control devices include infrared induction or capacitive induction non-contact control buttons, which can only realize the identification of existence of objects within a specific distance range.

### SUMMARY

An object of the present disclosure is to solve or at least alleviate the problems existing in the prior art.

A control device is provided, which includes a control panel including a plurality of buttons, the buttons including; a non-contact sensor, which is capable of sensing the approaching of an object and generating a proximity signal; and a micro switch, which is capable of generating a contact signal when the button is pressed.

Optionally, in an embodiment of the control device, the control panel includes: a button panel, the non-contact sensor being located on a back side of the button panel; and a printed circuit board, the non-contact sensor being electrically coupled to the printed circuit board; wherein the printed circuit board further includes a micro switch, and the button panel is supported by a spring member, so that pressing the button panel can further cause the micro switch on the printed circuit board to be pressed.

Optionally, in an embodiment of the control device, the non-contact sensor is a TOF sensor capable of sensing a distance from an object, and the proximity signal includes distance information.

Optionally, in an embodiment of the control device, the control device further includes a processor connected to the control panel to receive the proximity signal and the contact signal.

Optionally, in an embodiment of the control device, the processor is configured to, when receiving at least two proximity signals with gradually decreasing distance information sent by any designated button of the plurality of buttons in time sequence within a specific time period T, determine that the designated button is triggered.

Optionally, in an embodiment of the control device, the processor is configured to receive any two signals sent by any designated button of the plurality of buttons in time sequence within a specific time period T, wherein the two signals include first distance information a₁ and second distance information a₂ respectively, and when the two signals satisfy that the first distance signal a₁ is in a first distance range R₁ and the second distance signal a₂ is in a second distance range R₂, it is determined that the designated button is triggered, wherein an intermediate value of the first distance range R₁ is larger than an intermediate value of the second distance range R₂.

Optionally, in an embodiment of the control device, the processor is configured to receive any three signals sent by any designated button of the plurality of buttons in time sequence within a specific time period T, wherein the three signals include first distance information a₁, second distance information a₂ and third distance information a₃ respectively, and when the three signals satisfy that the first distance signal a₁ is in a first distance range R₁, the second distance signal a₂ is in a second distance range R₂ and the third distance signal a₃ is in a third distance range R₃, it is determined that the designated button is triggered, wherein an intermediate value of the first distance range R₁ is larger than an intermediate value of the second distance range R₂, and the intermediate value of the second distance range R₂ is larger than an intermediate value of the third distance range R₃.

Optionally, in an embodiment of the control device, the processor is configured to, when receiving the contact signal sent by the micro switch of any designated button of the plurality of buttons due to being pressed, determine that the designated button is triggered.

Optionally, in an embodiment of the control device, the button panel is a light-transmitting panel, and the printed circuit board is further provided with LED lights, which are lit up when the button is triggered.

Optionally, in an embodiment of the control device, the non-contact sensor is adhered to the back side of the button panel, and the button panel is elastically supported on the printed circuit board by a spring.

In another aspect, an elevator system is provided, which includes the control device according to various embodiments.

In further another aspect, a method for determining triggering of a control device is provided, wherein the control device includes a control panel including a plurality of buttons, the buttons include a non-contact sensor and a micro switch, and the method includes: generating a proximity signal when any one of the plurality of buttons senses the approaching of an object, the proximity signal including distance information; and when receiving at least two signals with gradually decreasing distance information sent by any designated button of the plurality of buttons in time sequence within a specific time period T, determining that the designated button is triggered.

Optionally, the method further includes receiving any two signals sent by any designated button of the plurality of buttons in time sequence within the specific time period T, wherein the two signals include first distance information a₁ and second distance information a₂ respectively, and when the two signals satisfy that the first distance signal a₁ is in a first distance range R₁ and the second distance signal a₂ is in a second distance range R₂, it is determined that the designated button is triggered, wherein an intermediate value of the first distance range R₁ is larger than an intermediate value of the second distance range R₂.

Optionally, the method further includes receiving any three signals sent by any designated button of the plurality of buttons in time sequence within the specific time period T, wherein the three signals include first distance information a₁, second distance information a₂ and third distance information a₃ respectively, and when the three signals satisfy that the first distance signal a₁ is in a first distance range R₁, the second distance signal a₂ is in a second distance range R₂ and the third distance signal a₃ is in a third distance range R₃, it is determined that the designated button is triggered, wherein an intermediate value of the first distance range R₁ is larger than an intermediate value of the second distance range R₂, and the intermediate value of the second distance range R₂ is larger than an intermediate value of the third distance range R₃.

Optionally, the method further includes: when receiving the contact signal sent by the micro switch of any designated button of the plurality of buttons due to being pressed, determining that the designated button is triggered.

The device and method according to the embodiments of the present disclosure can effectively identify contact triggering and non-contact triggering.

### BRIEF DESCRIPTION OF THE DRAWINGS

With reference to the accompanying drawings, the disclosure of the present disclosure will become easier to understand. It can be easily understood by those skilled in the art that these drawings are only for illustrative purpose, and are not intended to limit the scope of protection of the present disclosure. In addition, similar numbers in the drawings are used to denote similar components, in which:

FIG. 1 shows a schematic view of a control device according to an embodiment of the present disclosure;

FIG. 2 shows a schematic structural view of a button according to the embodiment of the present disclosure;

FIG. 3 shows a schematic principle view of a TOF sensor used by the button according to the embodiment of the present disclosure; and

FIGS. 4 and 5 show schematic views of typical signals collected by a TOF sensor.

### DETAILED DESCRIPTION

Reference is made to FIG. 1, which shows a control device according to an embodiment of the present disclosure. The control device includes a control panel 9 having a plurality of buttons, and the plurality of buttons may include a first button 1, a second button 2 and a third button 3 as illustrated. Although only three buttons are shown, in fact, the plurality of buttons refer to two or more than two buttons. The control device may be for example used as an elevator control device in a building, and the control panel may be installed in an elevator hall or elevator car. The plurality of buttons may be, for example, an elevator-calling button, a going-up button, a going-down button, a door-opening button, a door-closing button, a floor selecting button, and an alarm button in the elevator control panel, etc. In the embodiment according to the present disclosure, each button includes a non-contact sensor and a micro switch, wherein the non-contact sensor can sense that an object is approaching the button and generate a proximity signal, and the micro switch can generate a contact signal when the button is pressed. Therefore, the control device according to the embodiment of the present disclosure can be triggered in either a non-contact manner or a contact manner, which is friendly to people to whom non-contact triggering is inconvenient, such as blind people.

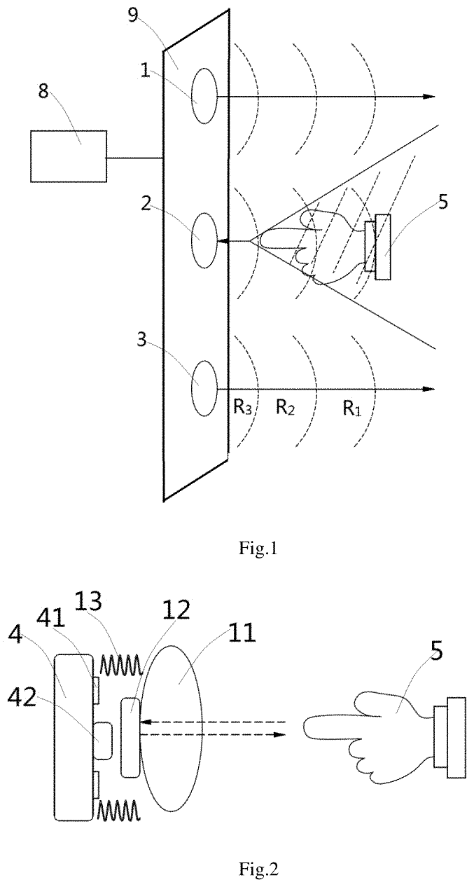

Continuing to refer to FIG. 2, in some specific embodiments, each of the plurality of buttons may include; a button panel 11; a non-contact sensor 12 located on a back side of the button panel 11, wherein the non-contact sensor 12 can sense the approaching of an object; and a printed circuit board 4, wherein the non-contact sensor 12 is electrically coupled to the printed circuit board 4, so that the non-contact sensor 12 can communicate with the printed circuit board 4 and can be powered by the printed circuit board 4. In addition, the printed circuit board 4 further includes a micro switch 42, and the button panel 11 is supported by a spring member 13, e.g., supported on the printed circuit board 4 or on a substrate of the control panel 9 shown in FIG. 1, so that the button panel 11 can further press the micro switch 42 on the printed circuit board 4, and the micro switch 42 generates a contact signal after being pressed. The printed circuit board 4 can be connected to some or all of the buttons in order to receive the proximity signal and the contact signal output by each button and send these signals to a processor 8. In some embodiments, the non-contact sensor 12 may be a proximity sensor based on infrared sensing, Hall effect sensing, etc., which can sense whether there is an object within a detectable distance, and output the proximity signal when there is an object. In some embodiments of the present disclosure, some or all of the plurality of buttons may be equipped with TOF sensors.

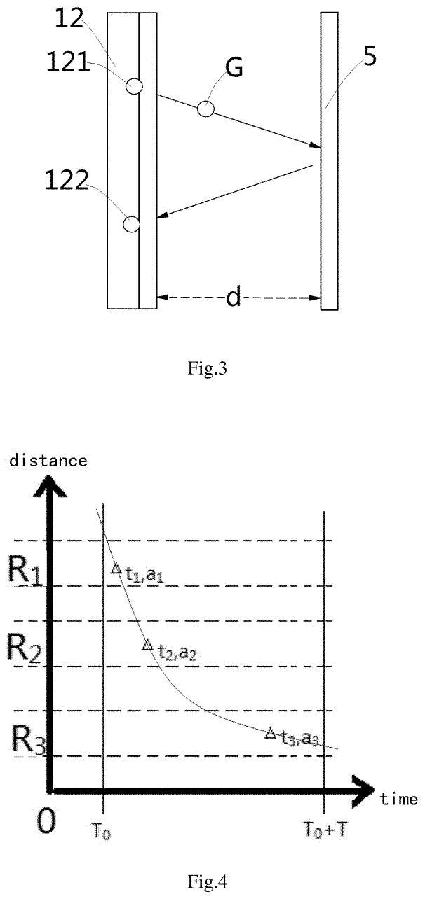

Continuing to refer to FIG. 3, a TOF (time of fly) sensor is also called a time-of-flight sensor. It can not only detect the approaching of an object, that is, detect whether the object is within a detectable distance, but also can detect information of the distance from the object to the button. The TOF sensor 12 may include a photon emitter 121 and a photon receiver 122. The photon emitter 121 emits a photon G, which is reflected after contacting an object 5, and which is received by the photon receiver 122. Through the time of fly of the photon G and the speed of light, the distance to the object 5 is calculated.

In some embodiments, as shown in FIG. 1, the control device further includes a processor 8. The printed circuit board 4 may be connected to the plurality of buttons and the processor 8, thereby realizing connections between the plurality of buttons and the processor 8, including electrical and/or signal connections. The processor 8 is connected to the plurality of buttons of the control panel 9 to receive proximity signals or contact signals sent by the plurality of buttons, wherein the proximity signals may include distance information. The processor 8 may be integrated at the control panel 9 or may be arranged remotely. In some embodiments, the processor 8 may be configured to, when receiving the contact signal sent by the micro switch of any designated button of the plurality of buttons due to being pressed, determine that the designated button is triggered (also referred to as contact triggering). In some embodiments, the panel 11 is a light-transmitting panel, and the printed circuit board 4 is further provided with LED lights 41, which are lit up after the button is triggered (including both the contact triggering, and non-contact triggering to be described in detail below).

In some embodiments, when the button is equipped with the TOF sensor, the processor 8 may be configured to, when receiving at least two or at least three proximity signals with gradually decreasing distance information sent by any one of the plurality of buttons (hereinafter referred to as designated button) in time sequence within a specific time period T, determine that the designated button is triggered (non-contact triggering). For example, the distance information of the first signal and the second signal sent by a button within a specific time period T sequentially is a₁ and a₂ respectively, and when a₁>a₂, it is determined that the button is triggered in a non-contact manner Alternatively, for example, the distance information of the first signal, the second signal and the third signal sent by a button within a specific time period T sequentially is a₁, a₂ and a₃ respectively, and when a₁>a₂>a₃, it is determined that the button is triggered in a non-contact manner Through such determination, an approaching operation of the finger can be accurately identified, and false triggering caused by misidentification can be avoided.

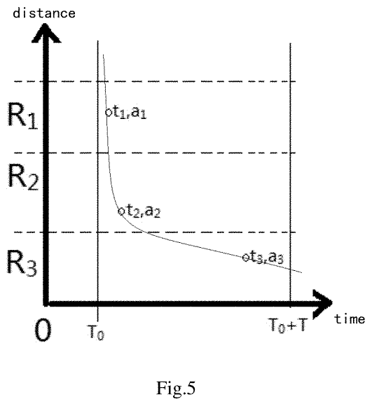

In some embodiments, the processor 8 may be configured to receive any three signals sent by any one of the plurality of buttons (hereinafter referred to as designated button) in time sequence within a specific time period T, wherein the three signals include first distance information a₁, second distance information a₂ and third distance information a₃ respectively, and when the three signals satisfy that the first distance signal a₁ is in a first distance range R₁, the second distance signal a₂ is in a second distance range R₂ and the third distance signal a₃ is in a third distance range R₃, it is determined that the designated button is triggered (non-contact triggering), wherein an intermediate value of the first distance range R₁ is larger than an intermediate value of the second distance range R₂, and the intermediate value of the second distance range R₂ is larger than an intermediate value of the third distance range R₃. For example, the third distance range R₃ may be an range of 0-2 cm of the distance from the button, with an intermediate value of 1 cm; the second distance range R₂ may be an range of 2-4 cm of the distance from the button, with an intermediate value of 3 cm; and the first distance range R₁ may be an range of 4-6 cm of the distance from the button, with an intermediate value of 5 cm. The first distance range R₁, the second distance range R₂ and the third distance range R₃ may be arbitrarily set within the detectable range of the TOF sensor. For example, as shown in FIGS. 1 and 5, the first distance range R₁, the second distance range R₂ and the third distance range R₃ may be adjacent. In some other embodiments, as shown in FIG. 4, the first distance range R₁, the second distance range R₂ and the third distance range R₃ may be spaced apart. Alternatively, although not shown, the first distance range R₁, the second distance range R₂ and the third distance range R₃ may also partially overlap. For example, the TOF sensor may collect N (such as 50, depending on the sampling frequency and the size of the time period T) signals including distance information in the specific time period T. If there are any three signals which satisfy that the first distance signal a₁ at time t₁ is in the first distance range R₁, the second distance signal a₂ at time t₂ is in the second distance range R₂ and the third distance signal a₃ at time t₃ is in the third distance range R₃, wherein t₁<t₂<t₃, then the processor 8 determines that the designated button is triggered in a non-contact manner. In some embodiments, in a case where there is no aforementioned non-contact triggering operation, the processor invalidates the received proximity signals. In this way, the triggering action of the user's finger approaching the button can be accurately captured, and other operations such as the user's translation on the panel can be filtered out. For example, even if the user's hand passes through identification areas of certain buttons when the user naturally puts down the hand after pressing the button, the signals detected by these buttons will be ignored because they do not meet the above identification conditions. The above-mentioned specific time period T may be selected based on actual conditions (for example, depending on the required sensitivity); for example, it may be in a range of 0.5-2 seconds, or for example, in a range of 0.8-1.5 seconds. As shown in FIG. 4 and FIG. 5, a calculation starting point To of the specific time period T may be any point or may be a designated point; for example, To is selected every other designated time range, such as 0.2 seconds.

In the above embodiments, three signals and three distance ranges are used as the judgment basis, and in some embodiments, only two signals and two distance ranges may be used as the judgment basis for non-contact button operation. In some embodiments, the processor 8 may be configured to receive any two signals sent by any designated button of the plurality of buttons in time sequence within a specific time period T, wherein the two signals include first distance information a₁ and second distance information a₂ respectively, and when the two signals satisfy that the first distance signal a₁ is in the first distance range R₁ and the second distance signal a₂ is in the second distance range R₂, it is determined that the designated button is triggered, wherein an intermediate value of the first distance range R₁ is larger than an intermediate value of the second distance range R₂.

Next, reference is made to FIGS. 4 and 5, which show typical curves from which non-contact button operations can be identified. It should be understood that the curves in the figures are fitted by collected signals, and the non-contact button operation can be determined as long as any three of the data points in the curves satisfy the condition.

According to another aspect, an elevator system is provided, wherein the elevator system includes the control device according to various embodiments, which serves as a hall control device or an in-car control device.

In further another aspect, a method for determining triggering of a control device is provided, wherein the control device includes a control panel including a plurality of buttons, and the method includes: generating a proximity signal when a non-contact sensor of the plurality of buttons senses the approaching of an object, the proximity signal including distance information; and when receiving at least two or at least three signals with gradually decreasing distance information sent by any designated button of the plurality of buttons in time sequence within a specific time period T, determining that the designated button is triggered in a non-contact manner The method for determining triggering according to the embodiment of the present disclosure can capture the action of the user's finger approaching the button and filter out other actions, so as to prevent the button from being false triggered.

In some embodiments, the method may further include receiving any three signals including first distance information a₁, second distance information a₂ and third distance information a₃ and sent by any designated button of the plurality of buttons in time sequence within a specific time period T, wherein when the three signals satisfy that the first distance signal a₁ is in a first distance range R₁, the second distance signal a₂ is in a second distance range R₂ and the third distance signal a₃ is in a third distance range R₃, it is determined that the designated button is triggered, wherein an intermediate value of the first distance range R₁ is larger than an intermediate value of the second distance range R₂, and the intermediate value of the second distance range R₂ is larger than an intermediate value of the third distance range R₃. By adopting distance range identification, the user's action of non-contact button pressing can be captured more accurately. In some embodiments, the method may further include: when receiving the contact signal sent by the micro switch of any designated button of the plurality of buttons due to being triggered, determining that the designated button is triggered.

The specific embodiments described above are merely for describing the principle of the present disclosure more clearly, and various components are clearly illustrated or depicted to make it easier to understand the principle of the present disclosure. Those skilled in the art can readily make various modifications or changes to the present disclosure without departing from the scope of the present disclosure. Therefore, it should be understood that these modifications or changes should be included within the scope of protection of the present disclosure.

What is claimed is:

1. A control device, comprising a control panel comprising a plurality of buttons, the buttons comprising;
a non-contact sensor, which is capable of sensing the approaching of an object and generating a proximity signal; and
a micro switch, which is capable of generating a contact signal when the button is pressed.

2. The control device according to claim 1, wherein the control panel comprises:
a button panel, the non-contact sensor being located on a back side of the button panel; and
a printed circuit board, the non-contact sensor being electrically coupled to the printed circuit board;
wherein the printed circuit board further comprises a micro switch, and the button panel is supported by a spring member, so that pressing the button panel can further cause the micro switch on the printed circuit board to be pressed.

3. The control device according to claim 1, wherein the non-contact sensor is a TOF sensor capable of sensing a distance from an object, and the proximity signal comprises distance information.

4. The control device according to claim 3, wherein the control device further comprises a processor connected to the control panel to receive the proximity signal and the contact signal.

5. The control device according to claim 4, wherein the processor is configured to, when receiving at least two or at least three proximity signals with gradually decreasing distance information sent by any designated button of the plurality of buttons in time sequence within a specific time period T, determine that the designated button is triggered.

6. The control device according to claim 4, wherein the processor is configured to receive any two signals sent by any designated button of the plurality of buttons in time sequence within a specific time period T, wherein the two signals comprise first distance information a₁ and second distance information a₂ respectively, and when the two signals satisfy that the first distance signal a₁ is in a first distance range R₁ and the second distance signal a₂ is in a second distance range R₂, it is determined that the designated button is triggered, wherein an intermediate value of the first distance range R₁ is larger than an intermediate value of the second distance range R₂.

7. The control device according to claim 4, wherein the processor is configured to receive any three signals sent by any designated button of the plurality of buttons in time sequence within a specific time period T, wherein the three signals comprise first distance information a₁, second distance information a₂ and third distance information a₃ respectively, and when the three signals satisfy that the first distance signal a₁ is in a first distance range R₁, the second distance signal a₂ is in a second distance range R₂ and the third distance signal a₃ is in a third distance range R₃, it is determined that the designated button is triggered, wherein an intermediate value of the first distance range R₁ is larger than an intermediate value of the second distance range R₂, and the intermediate value of the second distance range R₂ is larger than an intermediate value of the third distance range R₃.

8. The control device according to claim 4, wherein the processor is configured to, when receiving the contact signal sent by the micro switch of any designated button of the plurality of buttons due to being pressed, determine that the designated button is triggered.

9. The control device according to claim 6, wherein the button panel is a light-transmitting panel, and the printed circuit board is further provided with LED lights, which are lit up when the button is triggered.

10. The control device according to claim 2, wherein the non-contact sensor is adhered to the back side of the button panel, and the button panel is elastically supported on the printed circuit board by a spring.

11. An elevator system, comprising the control device according to claim 1.

12. A method for determining triggering of a control device, wherein the control device comprises a control panel comprising a plurality of buttons, the buttons comprise a non-contact sensor and a micro switch, and the method comprises:
generating a proximity signal when any one of the plurality of buttons senses the approaching of an object, the proximity signal comprising distance information; and
when receiving at least two or at least three signals with gradually decreasing distance information sent by any designated button of the plurality of buttons in time sequence within a specific time period T, determining that the designated button is triggered.

13. The method for determining according to claim 12, further comprising receiving any two signals sent by any designated button of the plurality of buttons in time sequence within the specific time period T, wherein the two signals comprise first distance information a₁ and second distance information a₂ respectively, and when the two signals satisfy that the first distance signal a₁ is in a first distance range R₁ and the second distance signal a₂ is in a second distance range R₂, it is determined that the designated button is triggered, wherein an intermediate value of the first distance range R₁ is larger than an intermediate value of the second distance range R₂.

14. The method for determining according to claim 12, further comprising receiving any three signals sent by any designated button of the plurality of buttons in time sequence within the specific time period T, wherein the three signals comprise first distance information a₁, second distance information a₂ and third distance information a₃ respectively, and when the three signals satisfy that the first distance signal a₁ is in a first distance range R₁, the second distance signal a₂ is in a second distance range R₂ and the third distance signal a₃ is in a third distance range R₃, it is determined that the designated button is triggered, wherein an intermediate value of the first distance range R₁ is larger than an intermediate value of the second distance range R₂, and the intermediate value of the second distance range R₂ is larger than an intermediate value of the third distance range R₃.

15. The method for determining according to claim 12, further comprising:
when receiving the contact signal sent by the micro switch of any designated button of the plurality of buttons due to being pressed, determining that the designated button is triggered.
